(19) United States
(12) Patent Application Publication
(10) Pub. No.: US 2025/0390705 A1
(43) Pub. Date: Dec. 25, 2025

(54) REFINING MACHINE LEARNING MODELS BASED ON CONTRASTIVE EXPLANATIONS OF MODEL BEHAVIOR

(71) Applicant: International Business Machines Corporation, Armonk, NY (US)

(72) Inventors: Ronny Luss, Glen Rock, NJ (US); Amit Dhurandhar, Yorktown Heights, NY (US)

(21) Appl. No.: 18/748,286

(22) Filed: Jun. 20, 2024

(51) Int. Cl. G06N 3/045; G06N 3/08

(52) U.S. Cl. CPC G06N 3/045; G06N 3/08

(57) ABSTRACT

According to one embodiment of the present invention, a system monitors behavior of machine learning models and comprises one or more memories and at least one processor coupled to the one or memories. The system generates a set of modified prompts from an identified prompt. A machine learning model produces responses for the identified prompt and the set of modified prompts. A modified prompt is selected from the set of modified prompts based on a change to a response for the selected prompt relative to a response for the identified prompt satisfying a change threshold associated with a change category. The selected prompt and corresponding response are presented and indicate changes to the identified prompt affecting behavior of the machine learning model. Embodiments of the present invention further include a method and computer program product for monitoring behavior of machine learning models in substantially the same manner described above.

### BACKGROUND

### 1. Technical Field

Present invention embodiments relate to machine learning models, and more specifically, to generating contrastive explanations of machine learning model behavior and refining the models based on the contrastive explanations.

### 2. Discussion of the Related Art

Large language models (LLMs) are machine learning models trained on massive datasets of unlabeled data. These LLMs are capable of learning general representations of the world that can be adapted to a wide range of downstream tasks. However, determining a basis for behavior of an LLM is difficult due to the complexity of the model.

### SUMMARY

According to one embodiment of the present invention, a system monitors behavior of machine learning models and comprises one or more memories and at least one processor coupled to the one or memories. The system generates a set of modified prompts from an identified prompt. A machine learning model produces responses for the identified prompt and the set of modified prompts. A modified prompt is selected from the set of modified prompts based on a change to a response for the selected prompt relative to a response for the identified prompt satisfying a change threshold associated with a change category. The selected prompt and corresponding response are presented and indicate changes to the identified prompt affecting behavior of the machine learning model. Embodiments of the present invention further include a method and computer program product for monitoring behavior of machine learning models in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is flow diagram of a manner of generating a contrastive explanation for large language model (LLM) behavior based on a greedy type search technique according to an embodiment of the present invention.

FIG. 3 is procedural flowchart of a method of refining a large language model (LLM) based on a contrastive explanation of large language model behavior generated by employing a greedy type search technique according to an embodiment of the present invention.

FIG. 4 is flow diagram of a manner of generating a contrastive explanation of large language model (LLM) behavior based on an intelligent type search technique according to an embodiment of the present invention.

FIGS. 5A-5C are a procedural flowchart of a method of refining a large language model (LLM) based on a contrastive explanation of large language model (LLM) behavior generated by employing an intelligent type search technique according to an embodiment of the present invention.

FIG. 6 is a flow diagram of a manner of generating a contrastive explanation for classifier behavior based on a greedy type search technique according to an embodiment of the present invention.

FIG. 7 is a flow diagram of a manner of generating a contrastive explanation for classifier behavior based on an intelligent type search technique according to an embodiment of the present invention.

### DETAILED DESCRIPTION

Large language models (LLMs) are machine learning models trained on massive datasets of unlabeled data. These LLMs are capable of learning general representations of the world that can be adapted to a wide range of downstream tasks. However, determining a basis for behavior of an LLM is difficult due to the complexity of the model.

Accordingly, an embodiment of the present invention generates a prompt that explains the large language model (LLM) generation (or behavior) with minimal perturbation to an original prompt, remains fluent, and contrasts an original response. The contrast may be measured based on any conventional or other distance measure for any type or category of change (e.g., a new response that is less preferable than an original response may have led to the final contrast, etc.). The embodiment explains language or response generation according to how humans understand.

For example, a large language model (LLM) may receive a prompt (e.g., “What should I get from the pharmacy for a cold?”) and produce a corresponding response (e.g., “a cough syrup”). An inquiry may question a reason for the LLM to provide such a response. An embodiment of the present invention may explain the response based on a modified response (e.g., the LLM outputs the response because if instead the prompt would have been a modified or different prompt, the response would have been much less preferable (or some other metric) than the original response). By way of further example, the modified prompt may be of the form “What can I expect when going to the doctor for a cold?”, and the LLM may produce a response of the form “They will prescribe some medicine to help you get better”. In this case, the modified response is less specific and less preferable (e.g., the modified response indicates medicine, whereas the original response indicates cough syrup).

An embodiment of the present invention provides humanly interpretable contrastive explanations for a large language model (LLM). A metric is utilized that gives meaning to how a prompt affects the response. The embodiment may efficiently search for a contrastive explanation subject to a fixed infilling budget. Embodiments of the present invention may use various search techniques to identify prompts providing a greatest change in a response based on the metric (e.g., a greedy search technique, an intelligent search technique, etc.).

An embodiment or the present invention receives input to analyze or evaluate a large language model (LLM). The input may include an LLM (to evaluate), an LLM-infill (an LLM to fill in masks in prompts and replace tokens or words), a metric (and corresponding threshold), and a prompt. The embodiment produces a contrastive prompt that generates a response that causes a sufficiently large change in the metric relative to a response to the input prompt. The technique of the embodiment is iterative. When the metric for the resulting contrastive prompt does not satisfy the input threshold, the contrastive prompt (causing a response with the largest change in the metric) is fed back and used as the prompt for the next iteration (e.g., a greedy type search technique). Alternatively, an intelligent search technique may be employed for the contrastive prompt causing the largest change in the metric. An embodiment may be adapted to provide contrastive explanations of classification models (or classifiers) processing input text.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

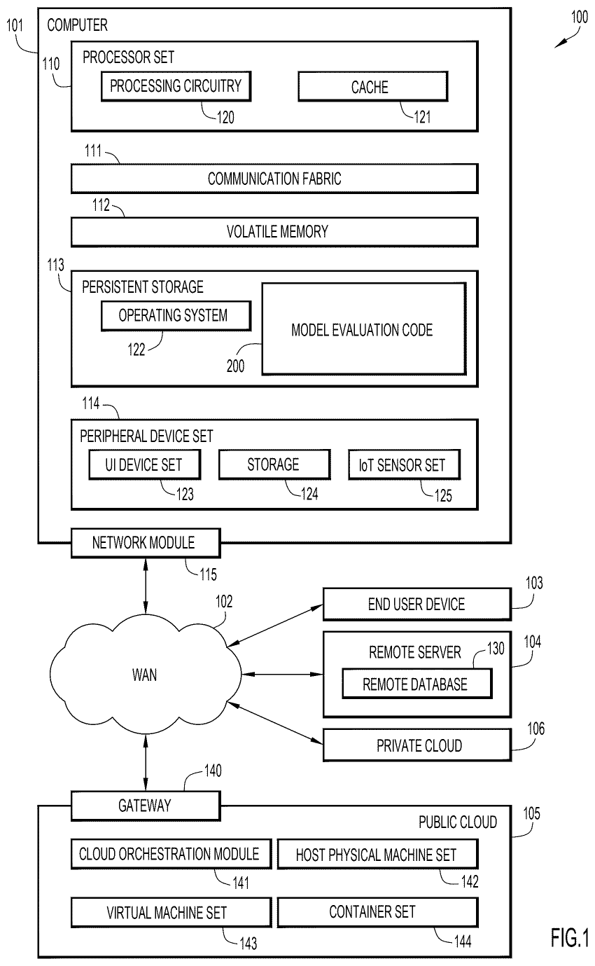

Referring to FIG. 1, computing environment 100 contains an example of an environment for the execution of at least some of the computer code involved in performing the inventive methods, such as model evaluation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

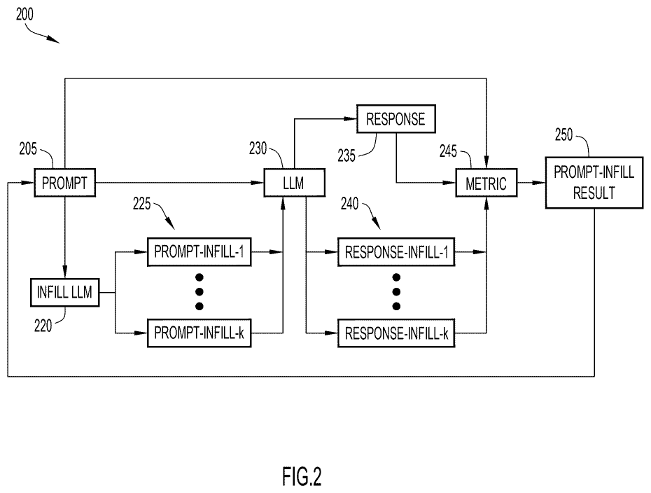

A manner of generating a contrastive explanation for large language model (LLM) behavior based on a greedy type search technique (e.g., via model evaluation code 200, computer 101, etc.) according to an embodiment of the present invention is illustrated in FIG. 2. Initially, model evaluation code 200 receives inputs or parameters, including a prompt 205, an infill LLM 220 (e.g., an LLM to fill in masks in prompts and replace tokens or words), an LLM 230 (to evaluate), and a metric 245 (and corresponding threshold). Prompt 205 is processed by LLM 230 to produce a response 235. The prompt is also processed by infill LLM 220 to produce a set of infill prompts 225 (e.g., prompt-infill-1 to prompt-infill-k as viewed in FIG. 2). The infill prompts are produced by replacing one or more tokens of prompt 205. A token may include any portion of a prompt (e.g., one or more words, any n-gram of two or more consecutive words, etc.). The tokens of the prompt to be replaced are indicated by prompt masks. For example, a mask may indicate words of a prompt to be replaced by new words. Each infill prompt has a different corresponding token of the input prompt replaced (e.g., for a prompt with k tokens, k infill prompts are generated with each infill prompt having a different token of the input prompt replaced). Infill LLM 220 may be any conventional or other LLM that can perform infilling (e.g., filling in a mask by selection of new tokens or words, or in this case, replacing a masked token of a prompt with a new token). By way of example, the infill LLM may include BART and/or T5, both of which can infill multiple words or tokens of a prompt (e.g., based on tokens surrounding or adjacent the token of interest, etc.). LLM 230 further processes infill prompts 225 to produce corresponding infill responses 240 (e.g., response-infill-1 to response-infill-k as viewed in FIG. 2).

The large language models (LLMs) (e.g., infill LLM 220 and LLM 230) are machine learning models trained on massive datasets of unlabeled data. These LLMs are capable of learning general representations of the world that can be adapted to a wide range of downstream tasks. The LLMs may employ any conventional or other large language model (LLM) and natural language processing (NLP) techniques to perform tasks. The LLMs may receive a prompt or natural language instruction, and process the prompt to extract and interpret the actions to be performed. The prompt may include several variations and forms. The prompt language to utilize may be obtained by generating various candidate prompts and determining metrics based on the output of the large language model (LLM) relative to desired or known results. The prompts or prompt language achieving greatest accuracy, performance, compliance, and/or other criteria may be used for the prompt provided to an LLM. In this way, prompts may be updated to adjust operation or behavior of the LLMs to improve performance or compliance, or to perform different tasks or behaviors. However, the LLMs may employ any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.).

A value for metric 245 is determined between response 235 and each infill response 240. The metric value represents a difference between response 235 and each infill response 240. The metric value may indicate the difference with respect to any desired type or category of change (e.g., preference, stigma, etc.). The metric may include any conventional or other distance measure (e.g., Stanford Human Preferences (SHP), natural language inference (NLI), bilingual evaluation understudy (BLEU), stigma, etc.).

The infill response 240 producing the greatest or largest metric value is determined. This corresponds to the infill response 240 that causes the greatest or largest change with respect to the response produced for prompt 205. This metric value is compared to the input threshold. When the metric value satisfies the threshold (e.g., greater than or equal to the threshold, etc.), model evaluation code 200 provides infill result 250 of the analysis. For example, the infill result may include infill response 240 producing the greatest metric value, corresponding infill prompt 225, input prompt 205, corresponding response 235 to the input prompt, and/or changes between the input and infill prompts (e.g., contrastive explanation) indicating the change in behavior of LLM 230. The result of the analysis may be presented on a display of an end user device (e.g., end user device 103).

When the largest metric value of infill responses 240 does not satisfy the input threshold, the corresponding infill prompt 225 producing the infill response 240 with the greatest metric value is fed back and used as the prompt for a next iteration. This basically implements a greedy type search technique to identify the infill prompt producing an infill response with the greatest change or effect (e.g., most/least preferable, etc.) relative to a response to the input prompt. The greedy search technique is preferable for prompts of shorter lengths. LLM 230 may be updated (or re-trained) based on the resulting prompt from the analysis to produce more preferable responses (e.g., convert prompts to the infill prompt, train the LLM to interpret the prompt as the infill prompt, add the infill prompt to a training set and re-train the LLM, etc.).

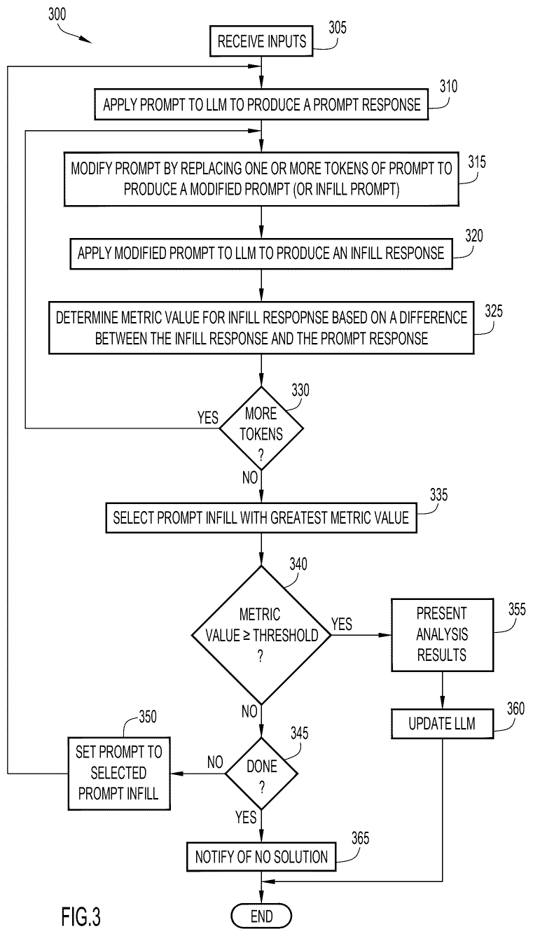

A method 300 of refining a large language model (LLM) based on a contrastive explanation of large language model behavior generated by employing a greedy type search technique (e.g., via model evaluation code 200, computer 101, etc.) according to an embodiment of the present invention is illustrated in FIG. 3. Initially, model evaluation code 200 receives inputs or parameters at operation 305. The inputs or parameters may include a prompt, an infill LLM (e.g., an LLM to fill in masks in prompts and replace tokens or words), an LLM (to evaluate), and a metric (and corresponding threshold). The large language models (LLMs) may be substantially similar to the LLMs described above (e.g., infill LLM 220 and LLM 230).

The prompt is applied to the LLM under evaluation to produce a prompt response at operation 310. The prompt is also processed by the infill LLM to produce a modified prompt (or infill prompt) at operation 315. The infill prompt is produced by replacing one or more tokens (e.g., one or more words, any n-gram of two or more consecutive words, etc.) of the prompt in substantially the same manner described above. The LLM further processes the modified or infill prompt to produce a corresponding infill response at operation 320.

A value for the metric is determined between the prompt response and the infill response based on a difference between the responses at operation 325. The metric value represents a difference between the prompt response and the infill response and may be determined in substantially the same manner described above. The above process is repeated from operation 315 until metric values for infill prompts produced from different combinations of replaced tokens (e.g., of prompt masks) have been produced as determined at operation 330 (e.g., prompt masks indicating replaceable tokens have been processed, etc.). For example, each infill prompt may have a different corresponding token of the input prompt replaced (e.g., for a prompt with k tokens, k infill prompts are generated with each infill prompt having a different token of the input prompt replaced).

The infill prompt (and response) producing the greatest or largest metric value is determined at operation 335. This corresponds to the infill response that causes the greatest or largest change with respect to the prompt response. This metric value is compared to the input threshold. When the metric value satisfies the threshold (e.g., greater than or equal to the threshold, etc.) as determined at operation 340, model evaluation code 200 provides analysis results at operation 355. For example, the analysis results may include the infill response producing the greatest metric value, corresponding infill prompt, input prompt, corresponding prompt response, and/or changes between the input and infill prompts (e.g., contrastive explanation) indicating the change in behavior of the LLM under evaluation. The analysis results may be presented on a display of an end user device (e.g., end user device 103).

In addition, the LLM may be updated (or re-trained) at operation 360 based on the resulting prompt from the analysis to produce more preferable responses (e.g., convert prompts to the infill prompt, train the LLM to interpret the prompt as the infill prompt, add the infill prompt to a training set and re-train the LLM, etc.).

When the largest metric value of the infill responses does not satisfy the input threshold as determined at operation 340, and the process is not completed (e.g., further iterations and/or combinations of replaceable tokens for producing infill prompts are desired, etc.) as determined at operation 345, the corresponding infill prompt producing the infill response with the greatest metric value is fed back and used as the prompt for a next iteration of the above process from operation 310. In this case, the prompt is set to the corresponding infill prompt producing the infill response with the greatest metric value at operation 350, and the above process is repeated from operation 310. This basically implements a greedy type search technique to identify the infill prompt producing an infill response with the greatest change or effect (e.g., most/least preferable, etc.) relative to a response to the input prompt. The greedy search technique is preferable for prompts of shorter lengths. Each iteration basically replaces an additional token in the input prompt to form the modified (or infill) prompts (e.g., an initial iteration may produce infill prompts with one token replaced, a next iteration produces infill prompts with two tokens replaced, etc.).

When the largest metric value of the infill responses does not satisfy the input threshold as determined at operation 340, and the process is completed (e.g., no additional iterations and/or combinations of replaceable tokens for producing infill prompts are desired, etc.) as determined at operation 345, a notification is provided that no solution was identified at operation 365. The notification may be presented on a display of an end user device (e.g., end user device 103). In other words, an infill prompt was not able to be identified that caused sufficient changes or differences to the response (e.g., within a desired amount of iterations, combinations of replaceable tokens for producing infill prompts, etc.).

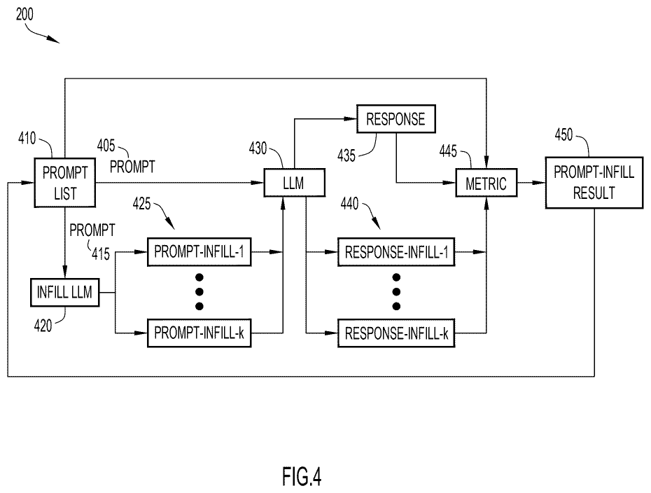

A manner of generating a contrastive explanation of large language model (LLM) behavior based on an intelligent search technique (e.g., via model evaluation code 200, computer 101, etc.) according to an embodiment of the present invention is illustrated in FIG. 4. Initially, model evaluation code 200 receives inputs or parameters, including a prompt 405 (e.g., text, etc.), an infill LLM 420 (e.g., an LLM to fill in masks in prompts and replace tokens or words), an LLM 430 (to evaluate), and a metric 445 (and corresponding threshold). Prompt 405 is processed by LLM 430 to produce a response 435 (e.g., text, etc.).

Model evaluation code 200 maintains a prompt list 410 of previously modified prompts which is used to produce infill prompts. The list is searched using an intelligent search technique to identify an infill prompt producing the greatest or largest change to the response produced from the input prompt. One or more prompts 415 are selected from prompt list 410 based on the intelligent search technique and are also processed by infill LLM 420 to produce a set of infill prompts 425 for each selected prompt 415 (e.g., prompt-infill-1 to prompt-infill-k as viewed in FIG. 4). The infill prompts may be produced by replacing one or more tokens (e.g., one or more words, any n-gram of two or more consecutive words, etc.) of selected prompts 415 (and optionally prompt 405) in substantially the same manner described above. Each infill prompt has a different corresponding token of a selected modified prompt replaced (e.g., for a modified prompt with k remaining tokens unreplaced, k infill prompts are generated with each infill prompt having a different unreplaced token of the selected modified prompt replaced). The tokens of the prompt to be replaced are indicated by prompt masks. For example, a mask may indicate words of a prompt to be replaced by new words. Infill LLM 420 and LLM 430 may be substantially similar to the LLMs described above (e.g., infill LLM 220 and LLM 230, etc.). LLM 430 further processes infill prompts 425 to produce corresponding infill responses 440 (e.g., response-infill-1 to response-infill-k (for each selected prompt 415) as viewed in FIG. 4).

A value for metric 445 is determined between response 435 and each infill response 440. The metric value represents a difference between response 435 and each infill response 440, and may be substantially similar to the metric described above (e.g., metric 245, etc.).

The metric values for infill responses 440 are compared to the input threshold. When a metric value satisfies the threshold (e.g., greater than or equal to the threshold, etc.), model evaluation code 200 provides infill result 450 of the analysis. For example, the result may include infill response 440 producing the metric value satisfying the threshold, corresponding infill prompt 425, input prompt 405, corresponding response 435 to input prompt 405, and/or changes between the input and infill prompts (e.g., contrastive explanation) indicating the change in behavior of LLM 430. The result of the analysis may be presented on a display of an end user device (e.g., end user device 103).

When the metric values of infill responses 440 do not satisfy the input threshold, infill prompts 425 are added to prompt list 410 for a next iteration. The intelligent search technique repeats the above process with new prompts selected from updated prompt list 410. This basically implements an intelligent type search (e.g., intelligent selection of prompts for infilling, etc.) to identify the infill prompt producing an infill response with a sufficient change or effect (e.g., most/least preferable, etc.) relative to a response to the input prompt. When a prompt is of a sufficiently long length (e.g., certain quantity of words or tokens, etc.), such as for text summarization or question-answer (QA), a limited search may be employed subject to a fixed budget (e.g., the greatest metric value is maintained and the analysis results are provided at expiration of the budget with respect to the infill prompt corresponding to the greatest metric value). The intelligent search technique may employ any conventional or other search techniques (e.g., exploration and exploitation, etc.).

LLM 430 may be updated (or re-trained) based on the resulting prompt from the analysis to produce more preferable responses (e.g., convert prompts to the infill prompt, train the LLM to interpret the prompt as the infill prompt, add the infill prompt to a training set and re-train the LLM, etc.).

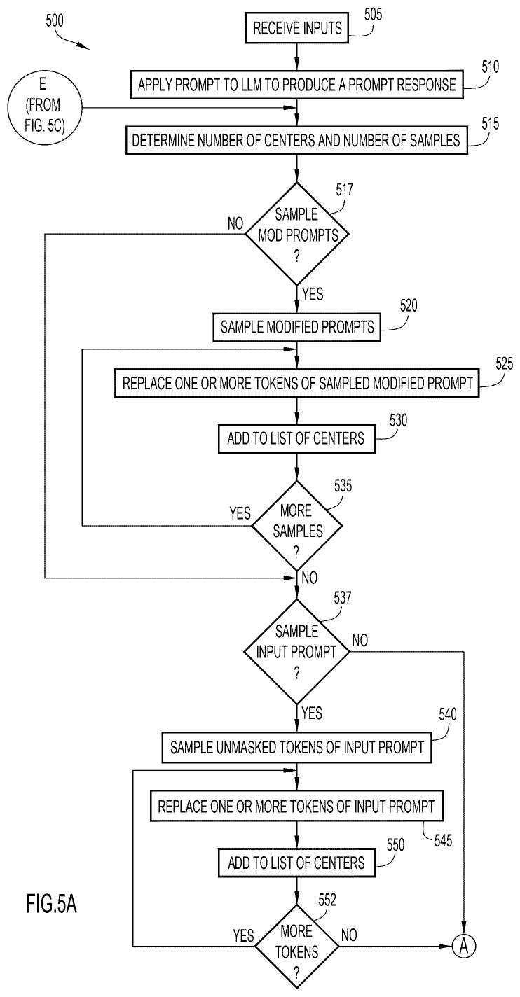

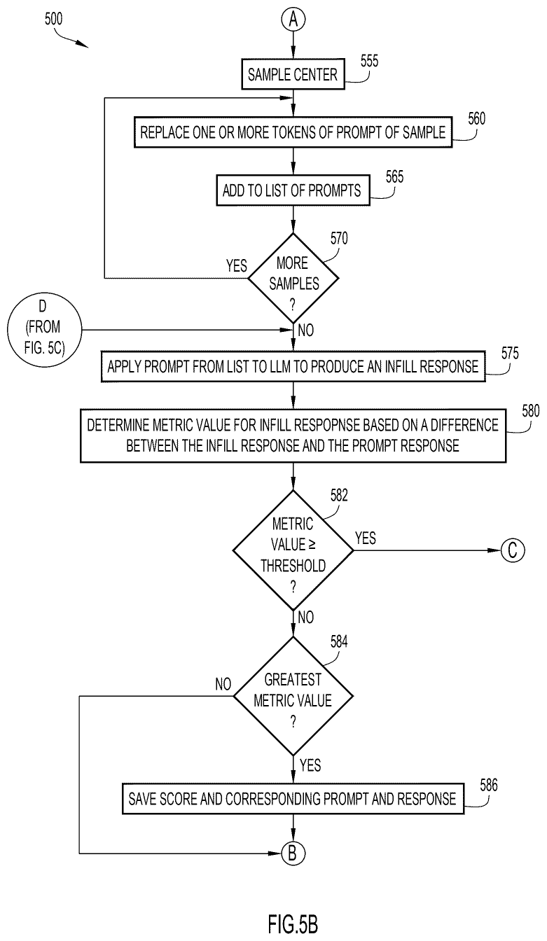

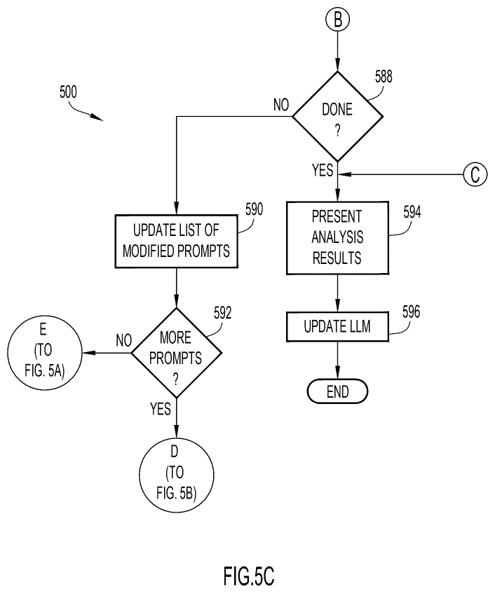

A method 500 of refining a large language model (LLM) based on a contrastive explanation of large language model (LLM) behavior generated by employing an intelligent search technique (e.g., via code evaluation model 200, computer 101, etc.) according to an embodiment of the present invention is illustrated in FIGS. 5A-5C. Initially, model evaluation code 200 receives inputs or parameters at operation 505 (FIG. 5A). The inputs or parameters may include a prompt (e.g., text, etc.), a budget (e.g., a constraint controlling or limiting the intelligent search technique, such as the number of calls to an LLM), a maximum number of iterations for the intelligent search technique, an infill LLM (e.g., an LLM to fill in masks in prompts and replace tokens or words), an LLM (to evaluate), and a metric (and corresponding threshold). The large language models (LLMs) may be substantially similar to the LLMs described above (e.g., infill LLM 220, 420 and LLM 230, 430).

The prompt is applied to the LLM under evaluation to produce a prompt response (e.g., text, etc.) at operation 510. A number of centers (or prompts) to search in a prompt space and a number of samples for the prompt space and input prompt is determined at operation 515. Basically, the intelligent search technique maintains a list of previously modified prompts and intelligently selects prompts (or potential centers) from the list to search for each iteration to identify the modified prompt causing a sufficient change in the response. The number of centers may be determined using any conventional other technique.

By way of example, the number of centers may be determined based on the budget and the iteration in the intelligent search technique. For example, the number of centers, m, may be determined as follows:

$$m = {2}^{t + 1} , when ( t + 1 ) \times {2}^{t} \leq B / log ( B ) ;$$

$$and$$

$$m = {2}^{t} , when ( t + 1 ) \times {2}^{t} > B / log ( B ) ;$$

where t is an iteration number (within the intelligent search technique) and B is the budget.

This function for the number of centers is inspired by optimal sampling from continuous distributions. Another option could be to grow the number of centers slowly. The number of samples for the input and modified prompts is based on the number of centers. By way of example, the intelligent search heuristic or technique splits the number of centers equally into searching tokens from the input prompt (e.g., exploration) and searching previously perturbed or modified prompts (e.g., exploitation). For example, the number of samples for the modified prompts may be determined as the minimum value from a group including the number of centers/2, and the number of modified prompts. The number of samples for the input prompt may be determined as the minimum value from a group of the difference between the number of centers and number of samples for the modified prompts, and the number of unmasked tokens in the input prompt (or tokens that have not been modified or replaced). Thus, samples may be obtained from the input and modified prompts. However, the number of centers and samples may be determined in any fashion (e.g., search in any manner between the modified prompts and initial prompt). For example, the initial prompt (e.g., exploration) may be used at the start of the intelligent search technique to search (when no or few modified prompts exist), and the modified prompts (e.g., exploitation) may be used after generation (and optionally with the input prompt) to search.

Modified prompts from prior iterations may be sampled and modified to produce additional centers for searching. The number of samples is based on the determined number of centers and the number of previously modified prompts as described above. When the modified prompts are to be sampled (e.g., the number of samples for the previously modified prompts is greater than zero) as determined at operation 517, the modified (or infill) prompts from prior iterations are sampled or obtained at operation 520 based on the number of samples. By way of example, the sampling is performed randomly, but may be based on any criteria (e.g., metric values, etc.).

A sampled modified prompt is obtained and processed by the infill LLM to produce a modified prompt (or infill prompt) at operation 525. The infill prompt is produced by replacing one or more tokens (e.g., one or more words, any n-gram of two or more consecutive words, etc.) of the sampled modified prompt (that have not been previously replaced) in substantially the same manner described above. The quantity of tokens to replace may be pre-configured or provided as a parameter. The resulting modified (or infill) prompt is added to a list of centers at operation 530. The above process is repeated from operation 525 until each sample has been obtained and processed as determined at operation 535. This yields a list of centers (or prompts) including the modified sampled prompts.

Once the sampled modified prompts have been processed or further modified (e.g., exploitation), the input prompt may be modified (e.g., exploration). Unmasked tokens of the input prompt (e.g., tokens that have not been replaced or modified) are sampled and replaced to produce additional centers for searching. The number of samples is based on the determined number of centers and the number of unmasked tokens in the input prompt as described above. When the input prompt is to be sampled (e.g., the number of samples for unmasked tokens of the input prompt is greater than zero) as determined at operation 537, the unmasked tokens of the input prompt are sampled at operation 540 based on the number of samples. By way of example, the sampling is performed randomly, but may be based on any criteria.

The input prompt is obtained and processed by the infill LLM to produce a modified prompt (or infill prompt) at operation 545. The infill prompt is produced by replacing the sampled token (e.g., one or more words, any n-gram of two or more consecutive words, etc.) of the input prompt in substantially the same manner described above. The resulting modified input prompt is added to the list of centers (including the previously modified prompts) at operation 550. The above process is repeated from operation 545 until the samples (or unmasked tokens) have been processed as determined at operation 552 yielding an updated list of centers (or prompts based on the previously modified prompts and input prompt).

Once the list of centers is produced, the intelligent search technique searches around the centers (or prompts) of the list. In other words, the prompts in the list of centers are further modified (e.g., by replacing one or more tokens that have not been previously replaced). A prompt is sampled or obtained from the list of centers at operation 555 (FIG. 5B). The sampled prompt is processed by the infill LLM to produce a modified prompt (or infill prompt) at operation 560. The infill prompt is produced by replacing one or more tokens (e.g., one or more words, any n-gram of two or more consecutive words, etc.) of the sampled prompt (that have not been previously replaced) in substantially the same manner described above. The quantity of tokens to replace may be pre-configured or provided as a parameter. This results in a set of modified prompts for the sampled prompt (or center) with each prompt having an infill for a different token. The resulting prompts are added to a list of modified (or infill) prompts at operation 565. The above process is repeated from operation 560 until the prompts from the list of centers have been processed as determined at operation 570. This yields a list of modified (or infill) prompts to be evaluated by the metric.

The LLM further processes the list of modified (or infill) prompts to produce corresponding infill responses. In particular, an infill prompt is retrieved from the list of infill prompts and processed by the LLM to produce a corresponding infill response at operation 575. A value for the metric is determined between the prompt response and the infill response based on a difference between the responses at operation 580. The metric value represents a difference between the prompt response and the infill response and may be determined in substantially the same manner described above.

This metric value is compared to the input threshold. When the metric value satisfies the threshold (e.g., greater than or equal to the threshold, etc.) as determined at operation 582, model evaluation code 200 provides analysis results at operation 594 (FIG. 5C). For example, the analysis results may include the infill response producing the metric value satisfying the threshold, corresponding infill prompt, input prompt, corresponding input prompt response, and/or changes between the input and infill prompts (e.g., contrastive explanation) indicating the change in behavior of the LLM under evaluation. The analysis results may be presented on a display of an end user device (e.g., end user device 103). In addition, the LLM may be updated (or re-trained) at operation 596 based on the resulting prompt from the analysis to produce more preferable responses (e.g., convert prompts to the infill prompt, train the LLM to interpret the prompt as the infill prompt, add the infill prompt to a training set and re-train the LLM, etc.).

When the metric value of the infill response does not satisfy the input threshold as determined at operation 582 (FIG. 5B), the metric value is compared to the current greatest metric value. When the metric value exceeds the current greatest metric value as determined at operation 584, the metric value is saved as the current greatest metric value along with the corresponding prompt and response at operation 586. When the process is completed (e.g., the maximum number of iterations has been attained, etc.) as determined at operation 588 (FIG. 5C), analysis results are provided with respect to the prompt/response with the current greatest metric value, and the LLM is updated (or re-trained) at operations 594, 596 as described above.

When the process is not completed (e.g., the maximum number of iterations has not been attained, etc.) as determined at operation 588, model evaluation code 200 updates the list of previously modified prompts with the current prompt at operation 590. The above process repeats from operation 575 (FIG. 5B) when additional prompts from the list are to be processed as determined at operation 592 (FIG. 5C). When the prompts from the list have been processed as determined at operation 592, the above process repeats from operation 515 (FIG. 5A) to determine new centers and perform another iteration.

By way of example, an embodiment of the present invention may receive an input prompt of “The boy ran the race and fell before the finish line”, and use a T5 infill large language model (LLM) and an SHP metric. The response to the input prompt produced by a large language model (LLM) under evaluation may include “He was embarrassed”. The embodiment may evaluate the LLM and produce results in substantially the same manner described above. The results indicate that a contrastive prompt of “The following day, he ran the race and fell before the finish line.” provides a corresponding response of “He was disappointed.” which is of a decreased preference. The results may further indicate the modifications made to the prompt.

By way of further example, the embodiment may use the T5 infill large language model (LLM) and an NLI metric. In this example case for the same input prompt described above, the results indicate a contrastive prompt indicating a medical condition with a response having a contradiction and indicating an outcome of the medical condition.

Contrastive explanations may be generated for classifiers, where input text may be modified to flip the classifier's output (e.g., change text so that it is classified as toxic instead of not toxic, etc.). An embodiment of the present invention may be adapted to generate contrastive explanations for classifiers in substantially the same manner described above, except that a dummy (or identity) large language model (LLM) is used that receives a text string and outputs the same text string. The dummy LLM is used in place of the LLMs under evaluation described above (FIGS. 2 and 4) and in combination with a classifier that generates values with respect to the classifier output (e.g., classification, etc.). The values may be used to determine probabilities for the classifier output (e.g., a probability for a class may be the value for the class divided by the sum of values of all classes, etc.). The embodiment determines the prompt causing a change in the classifier output and generates a contrastive explanation for classifier behavior as described below. The embodiment may use a greedy or intelligent search technique in substantially the same manner described above, and may be useful for explaining classification of large pieces of text.

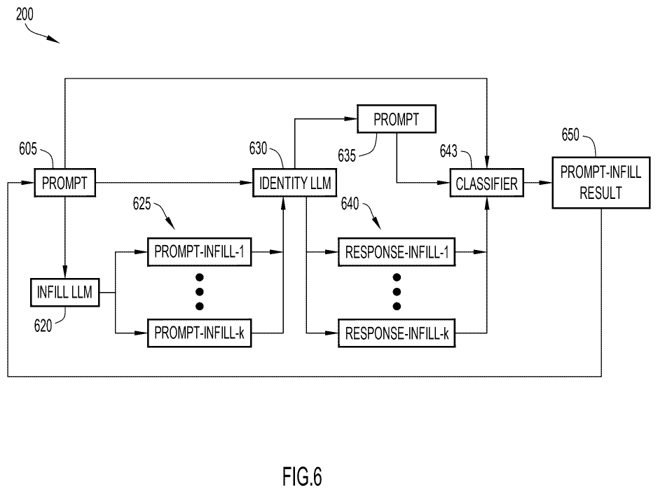

A manner of generating a contrastive explanation for classifier behavior based on a greedy type search technique (e.g., via code evaluation module 200, computer 101, etc.) according to an embodiment of the present invention is illustrated in FIG. 6. Initially, model evaluation code 200 receives inputs or parameters, including a prompt 605 (e.g., text, etc.), an infill LLM 620 (e.g., an LLM to fill in masks in prompts and replace tokens or words), an identity LLM 630, and a classifier 643 to evaluate (and corresponding threshold). Prompt 205 is processed by identity LLM 630 to produce a response or output 635 that is the same as the input prompt. For example, an input prompt of “What should I get from the pharmacy for a cold?” applied to identity LLM 630 produces a response (e.g., “What should I get from the pharmacy for a cold?”) that is the same as that input prompt.

The prompt is also processed by infill LLM 620 to produce a set of infill prompts 625 (e.g., prompt-infill-1 to prompt-infill-k as viewed in FIG. 6). The infill prompts are produced by replacing one or more tokens (e.g., one or more words, any n-gram of two or more consecutive words, etc.) of prompt 605. The tokens of the prompt to be replaced are indicated by prompt masks. For example, a mask may indicate words of a prompt to be replaced by new words. Each infill prompt has a different corresponding token of the input prompt replaced (e.g., for a prompt with k tokens, k infill prompts are generated with each infill prompt having a different token of the input prompt replaced). Infill LLM 620 may be any conventional or other LLM that can perform infilling (e.g., filling in a mask by selection of new tokens or words, or in this case, replacing a masked token of a prompt with a new token). By way of example, the infill LLM may include BART and/or T5, both of which can infill multiple words or tokens of a prompt. Identity LLM 630 further processes infill prompts 625 to produce corresponding infill responses 640 (e.g., response-infill-1 to response-infill-k as viewed in FIG. 6) that are the same as the infill prompts. The large language models (LLMs) (e.g., infill LLM 620 and identity LLM 630) are substantially similar to the LLMs described above.

Response (or prompt) 635 is processed by classifier 643 to classify the prompt among a plurality of classes. For example, the classes may indicate toxicity, stigma, etc. The classifier provides a value for each class indicating the likelihood of the prompt being within that class. The values may be used to determine probabilities as described above. The class with the highest value or probability is considered the class associated with the prompt. The classifier may classify the prompt into any desired categories or classes, and may employ any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.).

Infill prompts 625 are also applied to classifier 643 to produce a corresponding classification. The classifier provides a value for each class indicating the likelihood of an infill prompt being within that class. The values may be used to determine probabilities as described above. The class with the highest value or probability is considered the class associated with the infill prompt.

When an infill prompt changes the classification (or classifier output) relative to the input prompt and the value or probability for the classification (or corresponding class) satisfies the threshold (e.g., greater than or equal to the threshold, etc.), model evaluation code 200 provides infill result 650 of the analysis. For example, the result may include the infill prompt 625 producing the change in classification, corresponding new classification, input prompt 605, corresponding classification for the input prompt, and/or changes between the input and infill prompts (e.g., contrastive explanation) indicating the change in behavior of the classifier. The result of the analysis may be presented on a display of an end user device (e.g., end user device 103).

When none of the infill prompts cause a change to the classification, or the value or probability of a different classification does not satisfy the threshold, infill prompt 640 producing the greatest or largest value (or probability) for a different classification (or class) relative to the input prompt is determined. This infill prompt is fed back and used as the prompt for a next iteration. This basically implements a greedy type search to identify the infill prompt producing a change to the classification relative to a classification for the input prompt. The greedy search technique is preferable for prompts of shorter lengths. Each iteration basically replaces an additional token in the input prompt to form the modified (or infill) prompts (e.g., an initial iteration may produce infill prompts with one token replaced, a next iteration produces infill prompts with two tokens replaced, etc.). The greedy search technique may employ any conventional or other search techniques. For example, the greedy search technique may be substantially similar to the greedy search technique described above (FIG. 3).

Classifier 643 may be updated (or re-trained) based on the resulting prompt from the analysis to produce more preferable responses (e.g., convert prompts to the infill prompt, add the infill prompt to a training set and re-train the classifier, etc.).

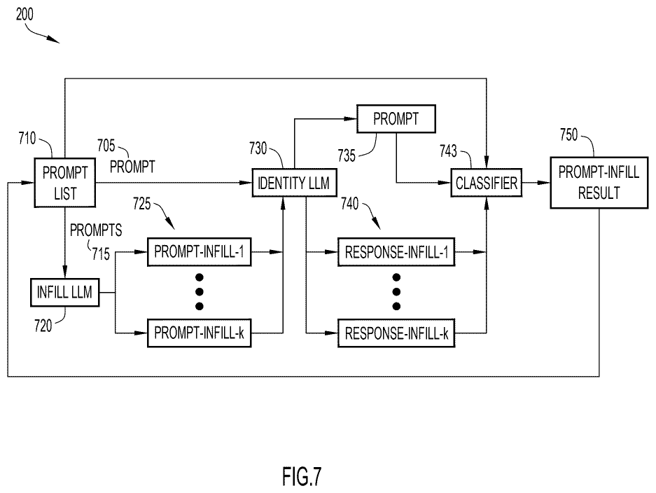

A manner of generating a contrastive explanation of classifier behavior based on an intelligent search technique (e.g., via model evaluation code 200, computer 101, etc.) according to an embodiment of the present invention is illustrated in FIG. 7. Initially, model evaluation code 200 receives inputs or parameters, including a prompt 705 (e.g., text, etc.), an infill LLM 720 (e.g., an LLM to fill in masks in prompts and replace tokens or words), an identity LLM 730, and a classifier 743 to evaluate (and corresponding threshold). Prompt 705 is processed by identity LLM 730 to produce a response or output 735 that is the same as the input prompt. For example, an input prompt of “What should I get from the pharmacy for a cold?” applied to identity LLM 730 produces a response (e.g., “What should I get from the pharmacy for a cold?”) that is the same as that input prompt.

Model evaluation code 200 maintains a prompt list 710 of previously modified prompts which is used to produce infill prompts. The list is searched using an intelligent search technique to identify an infill prompt producing a change in the output of classifier 743. One or more prompts 715 are selected from prompt list 710 based on the intelligent search technique and are also processed by infill LLM 720 to produce a set of infill prompts 725 for each selected prompt 715 (e.g., prompt-infill-1 to prompt-infill-k as viewed in FIG. 7). The selection or sampling may be random, or based on other criteria (e.g., classifier values, etc.).

The infill prompts may be produced by replacing one or more tokens (e.g., one or more words, any n-gram of two or more consecutive words, etc.) of selected prompts 715 (and optionally prompt 705) in substantially the same manner described above. Each infill prompt has a different corresponding token of a selected modified prompt replaced (e.g., for a modified prompt with k remaining tokens unreplaced, k infill prompts are generated with each infill prompt having a different unreplaced token of the selected modified prompt replaced). The tokens of the prompt to be replaced are indicated by prompt masks. For example, a mask may indicate words of a prompt to be replaced by new words. Infill LLM 720 and identity LLM 730 may be substantially similar to the LLMs described above. Identity LLM 730 further processes infill prompts 725 to produce corresponding infill responses 740 (e.g., response-infill-1 to response-infill-k as viewed in FIG. 7) that are the same as the infill prompts.

Response (or prompt) 735 is processed by classifier 743 to classify the prompt among a plurality of classes. For example, the classes may indicate toxicity, stigma, etc. The classifier provides a value for each class indicating the likelihood of the prompt being within that class. The values may be used to determine probabilities as described above. The class with the highest value or probability is considered the class associated with the prompt. The classifier may classify the prompt into any desired categories or classes, and may be substantially similar to the classifier described above.

Infill prompts 725 are also applied to classifier 743 to produce a classification. The classifier provides a value for each class indicating the likelihood of an infill prompt being within that class. The values may be used to determine probabilities as described above. The class with the highest value or probability is considered the class associated with the infill prompt.

The classifier values (or probabilities) for infill responses 740 are compared to the input threshold. When an infill prompt changes the classification (or classifier output) relative to the input prompt, and the value or probability for the classification (or corresponding class) satisfies the threshold (e.g., greater than or equal to the threshold, etc.), model evaluation code 200 provides infill result 750 of the analysis. For example, the result may include the infill prompt 725 producing the change in classification, corresponding new classification, input prompt 705, corresponding classification for the input prompt, and/or changes between the input and infill prompts (e.g., contrastive explanation) indicating the change in behavior of the classifier. The result of the analysis may be presented on a display of an end user device (e.g., end user device 103).

When none of the infill responses change the classification, or the value or probability of a different classification does not satisfy the threshold, infill prompts 725 are added to prompt list 710 for a next iteration. The intelligent search technique repeats the above process with new prompts selected from updated prompt list 710. This basically implements an intelligent type search (e.g., intelligent selection of prompts for infilling, etc.) to identify the infill prompt producing a change in classification relative to a classification of the input prompt. When a prompt is of a sufficiently long length (e.g., certain quantity of words or tokens, etc.), such as for text summarization or question-answer (QA), a limited search may be employed subject to a fixed budget (e.g., the greatest metric value is maintained and the analysis results are provided at expiration of the budget with respect to the infill prompt corresponding to the greatest metric value). The intelligent search technique may employ any conventional or other search techniques (e.g., exploration and exploitation, etc.). For example, the intelligent search technique may be substantially similar to the intelligent search technique described above (FIGS. 5A-5C).

Classifier 743 may be updated (or re-trained) based on the resulting prompt from the analysis to produce more preferable responses (e.g., convert prompts to the infill prompt, add the infill prompt to a training set and re-train the classifier, etc.).

By way of example, a prompt may be provided to the identity large language model (LLM) to produce a response (or the same prompt). The response is provided to a stigma classifier (e.g., with classes indicating the presence or absence of a stigma in the prompt). In this case, the prompt produces a classification indicating a presence of stigma in the prompt. The search techniques of embodiments described above (e.g., greedy search technique, intelligent search technique, etc.) may be employed to identify a modified version of the prompt that changes the classification (e.g., produces a prompt without stigma, etc.). The resulting modified prompt may be used to alter prompts and/or re-train the classifier.

Present invention embodiments may provide several technical and other advantages. For example, the models (LLM, classifier, etc.) may be analyzed by present invention embodiments and continuously updated (or re-trained) based on the analysis (e.g., prompts, etc. causing changes to responses) to improve model accuracy and performance. Further, the present invention embodiments utilize search techniques to quickly identify prompts causing changes with reduced iterations, thereby generating contrastive explanations and updating and/or re-training the models with reduced processing.

It will be appreciated that the embodiments described above and illustrated in the drawings represent only a few of the many ways of implementing embodiments for refining machine learning models based on contrastive explanations of model behavior.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., model evaluation code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., prompts, infill LLMs, LLMs for evaluation, classifiers for evaluation, metrics, thresholds, analysis results, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., prompts, infill LLMs, LLMs for evaluation, classifiers for evaluation, metrics, thresholds, analysis results, etc.).

The present invention embodiments are not limited to the specific tasks or algorithms described above, but may be utilized for evaluating and providing explanations for any machine learning models with any types of inputs and/or outputs (e.g., text, image, audio, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of monitoring behavior of machine learning models comprising:
generating, via at least one processor, a set of modified prompts from an identified prompt;
producing, via a machine learning model of the at least one processor, responses for the identified prompt and the set of modified prompts;
selecting, via the at least one processor, a modified prompt from the set of modified prompts based on a change to a response for the selected prompt relative to a response for the identified prompt satisfying a change threshold associated with a change category; and
presenting, via the at least one processor, the selected prompt and corresponding response indicating changes to the identified prompt affecting behavior of the machine learning model.

2. The method of claim 1, wherein the machine learning model includes a large language model.

3. The method of claim 2, wherein generating the set of modified prompts comprises:
replacing one or more tokens of the identified prompt to generate the set of modified prompts, wherein each modified prompt includes at least one different replaced token of the identified prompt.

4. The method of claim 2, wherein selecting a modified prompt comprises:
determining a metric value indicating a difference between the response for the identified prompt and the response for each modified prompt of the set of modified prompts;
determining a corresponding modified prompt with a greatest metric value; and
identifying the determined prompt as the selected prompt based on the greatest metric value associated with the determined prompt satisfying a threshold.

5. The method of claim 2, wherein the identified prompt is a previously modified prompt determined according to a greedy search technique.

6. The method of claim 2, wherein the identified prompt is a previously modified prompt selected according to an intelligent search technique.

7. The method of claim 1, wherein the machine learning model includes a classifier.

8. A system for monitoring behavior of machine learning models comprising:
one or more memories;
at least one processor coupled to the one or memories and configured to:
generate a set of modified prompts from an identified prompt;
produce, via a machine learning model, responses for the identified prompt and the set of modified prompts;
select a modified prompt from the set of modified prompts based on a change to a response for the selected prompt relative to a response for the identified prompt satisfying a change threshold associated with a change category; and
present the selected prompt and corresponding response indicating changes to the identified prompt affecting behavior of the machine learning model.

9. The system of claim 8, wherein the machine learning model includes a large language model.

10. The system of claim 9, wherein generating the set of modified prompts comprises:
replacing one or more tokens of the identified prompt to generate the set of modified prompts, wherein each modified prompt includes at least one different replaced token of the identified prompt.

11. The system of claim 9, wherein selecting a modified prompt comprises:
determining a metric value indicating a difference between the response for the identified prompt and the response for each modified prompt of the set of modified prompts;
determining a corresponding modified prompt with a greatest metric value; and
identifying the determined prompt as the selected prompt based on the greatest metric value associated with the determined prompt satisfying a threshold.

12. The system of claim 9, wherein the identified prompt is a previously modified prompt determined according to one of a greedy search technique and an intelligent search technique.

13. The system of claim 8, wherein the machine learning model includes a classifier.

14. A computer program product for monitoring behavior of machine learning models, the computer program product comprising one or more computer readable storage media having program instructions collectively stored on the one or more computer readable storage media, the program instructions executable by at least one processor to cause the at least one processor to:
generate a set of modified prompts from an identified prompt;
produce, via a machine learning model, responses for the identified prompt and the set of modified prompts;
select a modified prompt from the set of modified prompts based on a change to a response for the selected prompt relative to a response for the identified prompt satisfying a change threshold associated with a change category; and
present the selected prompt and corresponding response indicating changes to the identified prompt affecting behavior of the machine learning model.

15. The computer program product of claim 14, wherein the machine learning model includes a large language model.

16. The computer program product of claim 15, wherein generating the set of modified prompts comprises:
replacing one or more tokens of the identified prompt to generate the set of modified prompts, wherein each modified prompt includes at least one different replaced token of the identified prompt.

17. The computer program product of claim 15, wherein selecting a modified prompt comprises:
determining a metric value indicating a difference between the response for the identified prompt and the response for each modified prompt of the set of modified prompts;
determining a corresponding modified prompt with a greatest metric value; and
identifying the determined prompt as the selected prompt based on the greatest metric value associated with the determined prompt satisfying a threshold.

18. The computer program product of claim 15, wherein the identified prompt is a previously modified prompt determined according to a greedy search technique.

19. The computer program product of claim 15, wherein the identified prompt is a previously modified prompt selected according to an intelligent search technique.

20. The computer program product of claim 14, wherein the machine learning model includes a classifier.
